(19) United States
(12) Patent Application Publication
(10) Pub. No.: US 2007/0214218 A1
(43) Pub. Date: Sep. 13, 2007

(54) Publication management system

(76) Inventors: Patricia A. Ward, Barrington, NJ (US); Lee D. Fife, Hygiene, CO (US); Stephen R. Goodrich, Westwood, MA (US)

Correspondence Address: BRINKS HOFER GILSON & LIONE, P.O. BOX 10395, CHICAGO, IL, 60610, US

(21) Appl. No.: 11/371,189

(22) Filed: Mar. 8, 2006

(51) Int. Cl. G06F 15/16

(52) U.S. Cl. 709/205

(57) ABSTRACT

A publication management system connects to a network and stores publication related data and content related data. Based on the data, the system generates publication and/or content schedules. The system may include a processor, and a storage device. The processor may access publication related data and content related data. The processor may generate publication and/or content schedules, and monitor the progress of the publication and/or content schedules.

### BACKGROUND

The present disclosure relates to a management system, and more particularly to a system that manages publication data.

Publishers of printed or electronic publications typically need to manage a number of different documents during the process of creating a publication. A number of systems and discrete software applications exist that can help manage publication tasks. Some publication systems may manage document scheduling. In some systems, documents may be stored in a centralized location and the stored documents may be shared among remote users.

In some publication systems, document management is directed only towards the completion of the individual documents that make up a publication. In such systems, publications incorporating these individual documents may not be efficiently managed. For example, employees may be required to manually track publication tasks that are to be performed after the individual documents have been created. In such cases, an employee lapse may cause a delay in, or prevent, the distribution of a publication. Therefore, there is a need for an improved publication management system.

### SUMMARY

In order to address the need for improved publication management, a publication management system and method are disclosed. In one aspect, a publication management system connected to a network stores publication related data and content related data. Based on the data, the system generates publication and/or content schedules. The system may include a processor, and a storage device. The processor may access publication related data and content related data. The processor may generate publication and/or content schedules, and/or monitor the progress of the publication and/or content schedules.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The discussion below may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a publication monitoring system.

FIG. 2 is a diagram of a graphical user interface for monitoring publications.

FIG. 3 is a diagram of a graphical user interface for managing metadata associated with publication content files.

FIG. 4 is an alternate diagram of a graphical user interface for managing metadata associated with publication content files.

FIG. 5 is a diagram of a graphical user interface for managing publication level and/or content level milestones.

FIG. 6 is a diagram of a graphical user interface for customizing an issue schedule.

FIG. 7 is a diagram of a graphical user interface for customizing an article schedule.

FIG. 8 is a diagram of a graphical user interface for monitoring the status of an issue workflow.

FIG. 9 is a diagram of a graphical user interface for monitoring the status of an article workflow.

FIG. 10 is a diagram of a graphical user interface for providing information to a user of publication monitoring system.

FIG. 11 is a diagram of a graphical user interface for conveying task information to a user.

FIG. 12 is a diagram of a graphical user interface for monitoring publication page usage.

FIG. 13 is a diagram of a graphical user interface for selecting a publication layout version.

FIG. 14 is a diagram of a graphical user interface for managing the content included in a publication layout.

FIG. 15 is a diagram of a graphical user interface for configuring printed matter settings in a publication layout.

FIG. 16 is a diagram of a graphical user interface for inserting alternative data content in a publication layout.

FIG. 17 is a partial flow diagram of a publication monitoring system.

### DETAILED DESCRIPTION OF THE PREFERRED EMBODIMENTS

A system monitors scheduling deadlines for publication data received through a network. The system processes publication data and/or content data and automatically generates due dates for points of significant interest within a publication and/or content workflow. The system monitors the progress of a content and/or publication workflow and may alert a user of a scheduling status condition. Additionally, the system generates reports that may be reviewed by a user to gather further insight on the content and/or publication workflow.

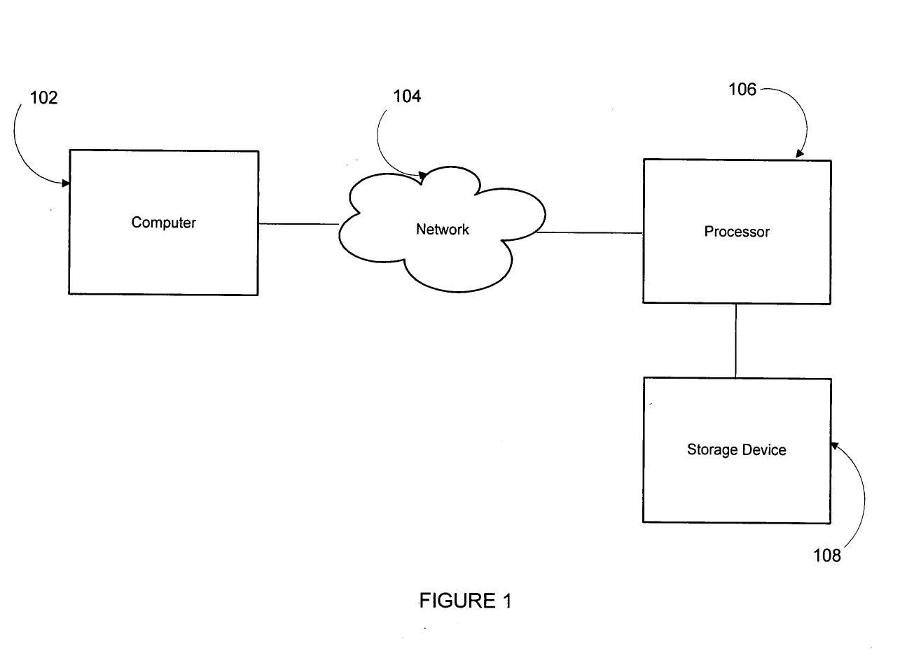

FIG. 1 is a block diagram of a publication monitoring system. The system may include hardware or software that is capable of running on one or more processors in conjunction with one or more operating systems. The system may include at least one computer 102, a processor 106 configured to connect to a network 104, such as a public or privately available distributed network, and storage device 108.

A private network may be a network in which the network links are separate from publicly accessible communication links. Virtual private networks may be networks that utilize secure communications over publicly accessible communication links. Virtual private networks may be implemented in a publicly accessible network. Publicly or privately accessible networks may be configured to use open or secure connections.

In FIG. 1, a fixed or mobile processing device, such as a computer 102 may reside at a remote location from processor 106 or be located proximate to processor 106. Computer 102 may comprise a network access device configured to permit a user to communicate with processor 106 through network 104. Alternatively, computer 102 may be coupled to an external network access device configured to permit communications with processor 106 through network 104. Communications through network 104 may be transmitted and/or received through a wired and/or wireless signal medium. Communications through wired signal medium may include transmissions through plain old telephone service (“POTS”) lines via a modem and a public switched telephone network (“PSTN”), Ethernet, and/or Digital Subscriber Lines (“DSL”). Communications through wireless signal medium may include transmissions through 802.11b, 802.11j, 802.11g, Zigbee®, Wideband, Mobile FI, Bluetooth®, and/or other developing wireless protocols. Transmissions over wired and/or wireless signal mediums may be represented in multiple protocols, such as Hyper Text Transfer Protocol (“HTTP”), Extensible Markup Language (“XML”) over HTTP, Simple Network Management Protocol (“SNMP”) over Transmission Control Protocol/Internet Protocol (“TCP/IP”), Simple Object Access Protocol over TCP/IP, as well as proprietary protocols developed in house and by others.

A user may use a computer 102 to access an application, such as EMC's Documentum, residing in processor 106 to generate graphical representations of workflows. Workflows may be created on a publication and/or content level, and may comprise information indicating the processes involved in generating a printed and/or electronic collection of data. Persons responsible for completing such processes may be associated with the workflows, and various processes in a workflow may be sub-grouped into points of significant interest, such as milestones.

Publication level workflows may be directed towards the processes involved in generating publications such as journals, magazines, periodicals, and/or catalogs. Publication workflows may include such processes as approving the text of the printed matter to be included in a publication, approving a publication's layout, and/or releasing a publication to press for printing. Content level workflows may be directed towards the processes involved in generating content data included within a publication, such as an article, abstract, advertisement, chart, and/or graphics. Content workflows may include providing the content to a copyeditor, receiving corrections and/or comments from a copyeditor, forwarding a copyeditor's comments to the content author for review, and/or incorporating additional changes received from the author. In addition to creating workflows, a user may establish customizable durations, identifying an amount of time or number of days to complete a workflow task and/or a milestone. Workflow processes may vary depending on the type of publication and/or the type of content. For example, the workflow associated with a continuing medical education article which requires peer review by a crediting society may include workflow processes not required for content data included in a non-technical journal.

Data indicating workflows, milestones, and durations may be transmitted to processor 106 in a time that occurs at or near the same rate of time perceived by humans, such as real-time. Alternatively, this data may be transmitted in batches, such that there is a delay between the time the data is entered and the time the data is transmitted. Data transmitted in real or delayed time may occur sequentially or simultaneously. The transmitted data may be stored in storage device 108. Storage device 108 may comprise a volatile and/or non-volatile memory local to processor 106, and/or a remote storage accessible to processor 106, such as a database management system and/or a server.

Processor 106 may be configured to receive content data transmitted by a computer 102. Content data may comprise data that may be incorporated into a publication, such as data included in manuscript submission software (e.g., Editorial Manager®, ScholarOne®, and/or BenchPress®, etc.), advertisement art in one of a variety of formats (e.g., Joint Photographic Experts Group (“JPG/JPEG”), Graphics Interchange Format (“GIF”), Bitmap, PowerPoint Presentations (“PPT”), Tagged Image File Format (“TIFF”), Embedded Post Script (“EPS”), etc.), and/or texts represented in one of a variety of formats (e.g., Microsoft Word®, Microsoft Works®, Wordperfect®, Portable Document Format (“PDF”), HTML, etc.). The transmitted content data may be transmitted in its normal format, or may be transmitted in a format that requires less space than usual, and may be stored in storage device 108. Alternatively, processor 106 may be configured to access content data previously stored in storage device 108.

Processor 106 may analyze received and/or stored content data and extract portions of data describing the content data as well as when, how, and/or by whom the data was created and/or transmitted, such as metadata. The metadata may comprise author and/or editor data, title data, issue data, volume data, file type, file size, transmission date, transmission time, receive date, receive time, and/or transmitting user information. Metadata may be stored in storage device 108.

Processor 106 may be configured to automatically generate data indicating content related milestone deadlines. Content related milestone deadlines may be forward and/or backwards generated depending on the configuration of the content level durations. Processor 106 may perform arithmetic and/or logic operations to determine a milestone deadline. In one implementation, a forward generated deadline may be determined by adding to an immediately preceding milestone's deadline the duration period for a present milestone. Similarly, in some implementations, a backward generated deadline may be determined by subtracting the duration period for a present milestone from an immediately subsequent milestone's deadline. Processor 106 may generate the content milestone deadline data based on a user identified content parameter, such as the date the content data is received by the system. Content related milestone deadline data may be stored in storage device 108.

Upon generating data indicating content milestone deadlines, processor 106 may track the progress of the content data through an associated content level workflow. Tracking the progress of content data through a content level workflow may include event-driven monitoring, such as monitoring the work performed by one or more users on some or all of the content data. This may include processor 106 generating tracking data indicative of when and/or by whom work related to the associated content data is performed. This tracking data may include a timestamp and/or user identification data. Processor 106 may compare tracking data to milestone deadline data and/or workflow durations to determine when a workflow process and/or milestone have been completed. Based on the results of the content level comparisons, processor 106 may generate alerts indicative of a content level condition which may then be transmitted to some or all of the system's users. Alerts may indicate that a milestone has been completed. Alternatively, alerts may provide reminder information to some or all of the users that a deadline is approaching, or indicate that a milestone's duration has expired prior to completion. Tracking data may be stored in storage device 108.

Storage device 108 may include publication scheduling control data. This data may comprise a month and/or day and/or year designating when a particular publication milestone is to be completed, such as a date a journal is to be mailed to subscribers. Processor 106 may access publication scheduling control data and automatically generate data indicating the deadlines for other milestones associated with the particular publication milestone, such as the date the final content to be included in the publication is to be received, the date by which the publication text is to be approved, the date by which the publication layout is to be released, and/or the date by which the data included within the publication is to be provided to a printer. Publication deadline data may be forward generated and/or backwards generated depending upon the configuration of the workflow. Publication level deadline data may be stored in storage device 108.

In response to user instructions transmitted from a computer 102, processor 106 may associate some or all of content data with a publication level workflow. When some content data is associated with a publication level workflow, processor 106 may track the progress of publication level milestone deadlines in light of the associated content level milestone deadlines. Processor 106 may track publication level milestone deadlines by comparing completed and/or uncompleted content level deadline data to publication level milestone deadline data. Based on the results of the publication level comparisons, processor 106 may generate alerts indicative of a publication level condition which then may be transmitted to some or all of the system's users. Alerts may indicate that a milestone has been completed. Alternatively, alerts may indicate that a milestone's deadline is approaching, or that a milestone's duration has expired prior to completion. Tracking data may be stored in storage device 108.

In addition to generating alerts, processor 106 may generate notification messages in response to user configurable notification parameters. Notification parameters may include which persons should be notified for each generated notification, during which time periods person should be notified, and/or how many notifications should be transmitted. Processor 106 may cause notifications to be transmitted across wired and/or wireless signal mediums. A notification may include an alert, and/or may indicate workflows that are behind schedule, content data that is ready for the performance of a subsequent workflow process, report information, and/or general information, such as a welcome letter to an author.

Processor 106 may access some or all of the data stored in storage device 108, and may generate monitoring data files. Monitoring data files may comprise an address of a location in storage device 108 where content data is stored; publication information data, such as a publication name or issue data; content information data, such as content type, content name, author and/or editor data; publication level and/or content level milestone data, such as name, deadline data, duration data; notification data, and or statistical data. Monitoring data files may be saved as a Hypertext Markup Language (“HTML”) file, and may be generated in real-time and/or delayed time. Alternatively, monitoring data files may be exported into a file for use with various types of software programs for data analysis.

A publication monitoring system may include alternative configurations. In some systems, the calculation of milestone deadlines may utilize a non-Gregorian calendar. In such systems, a business calendar that permits scheduling of workflow tasks only on business days may be used. Alternatively, a holiday calendar may be used which prohibits the scheduling of workflow tasks on holidays. The holiday calendar may include holidays for one or more religions and/or nationalities. The system may determine milestone deadlines by utilizing one or more non-Gregorian calendars.

In some publication systems, the milestone durations created during the initial configuration of publication level and/or content level workflows may be modified by an authorized user through a computer 102. Processor 106 may be programmed with a list of authorized users, which may include user IDs and/or user specific passwords. At any time during the publication monitoring process, an authorized user may transmit data to modify one or more deadlines associated with publication level and/or content level milestones. The transmitted modification data may change the month and/or day and/or year of a milestone deadline. This change may cause processor 106 to generate new data indicative of the new duration. Alternatively, the transmitted modification data may change the duration of a milestone. This change may cause processor 106 to generate a new month and/or day and/or year deadline for the associated milestone.

In some systems, processor 106 may be configured to generate and/or receive data indicative of a deadline external to a monitored publication process. This external deadline data may be stored in storage device 108, and accessed by a user. Processor 106 may not analyze or track the external deadline data since a process associated with this data is external to the system. However, a user may review the external deadline data and may follow up with the responsible persons to ensure that associated tasks are completed. External deadline data may include a date when mailing labels must be received in order to meet a publication mailing deadline, the latest date that a manuscript or advertising information may be received in order to meet a publication mailing date, the date storage facilities must be available to store excess publications, etc.

In some systems, processor 106 may be configured to manage content layout within a publication. This may include determining what content data may be available for inclusion in one or more publications (e.g., which articles, advertisements, and/or market information, such as letters to the editor and/or cover pages, may be included), configuring a publication's page numbering, and/or other printer specific information, such as colors.

In some publication monitoring systems, processor 106 may include logic configured to prevent an unauthorized user from accessing the system. Hardware, software, or a combination of both may be used to prevent unauthorized use of the system. The logic may (1) examine data received or transmitted from processor 106 and accept or reject the data based on user-defined-rules; (2) apply security mechanisms to specific applications, such as File Transfer Protocol or Telnet services, (3) apply security mechanisms when a connection such as a TCP is established such that, once a connection is made, data may flow freely between a computer 102 and processor 106 without further checking, or (4) intercept all messages received or transmitted from processor 106. The logic may utilize one or more of these techniques separately or in combination.

As shown in FIG. 1, the present disclosure may be implemented using any number of personal computers as the at least one computer 102. Processor 106 may be a personal computer or a computer configured to operate as a server. Processor 106 is configured to run an operating system, such as Windows, Unix, or Linux, as well as Documentum software available from ECM and PubFusion software available from Ovid Technologies.

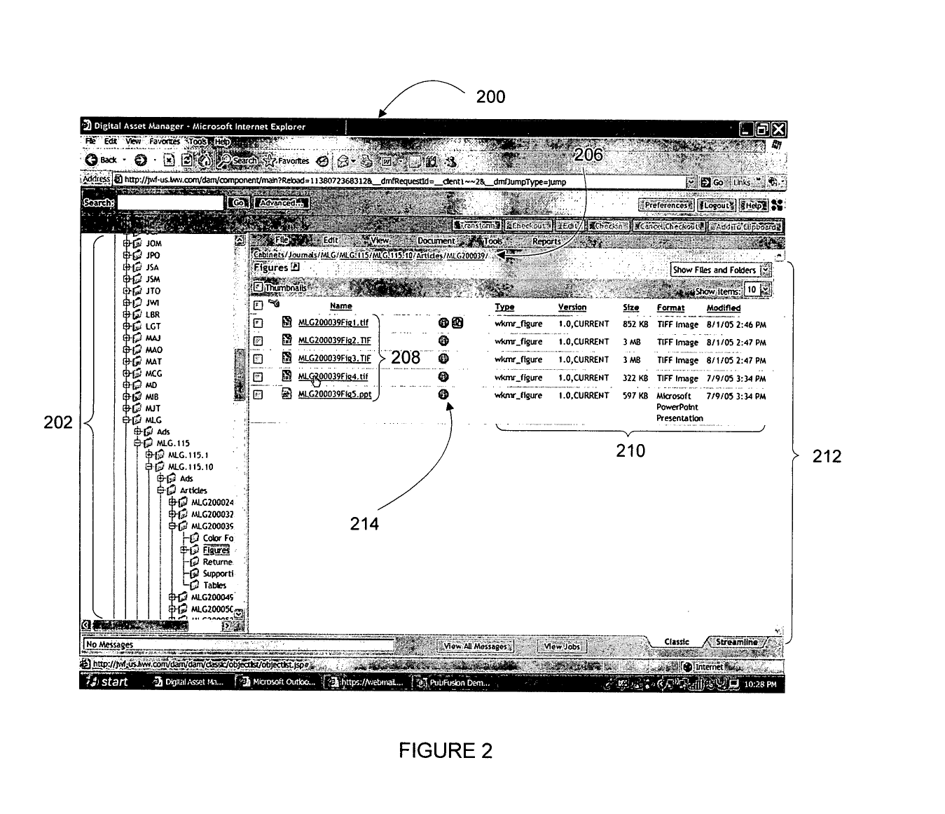

FIG. 2 is a diagram of a graphical user interface (“GUI”) 200 of an application running on processor 106 for monitoring publications. To access publication related data, a user may move through a directory structure 202. Directory structure 202 may identify one or more publications stored in storage device. As a user transitions through directory structure 202, subdirectories and/or files containing data associated with a particular publication may be identified. Subdirectories and/or files may contain content data, such as advertisement information and/or article information. Data representing a user's current directory location may be represented in a path field 206. The data represented in path field 206 may be in HTML format and may permit a user to quickly move to a particular portion of directory structure 202. When a user opens a folder or subfolder that comprises publication and/or content related data, a link 208, such as a HTML link, to the related data and identifying information associated with the data 210 may be displayed in display area 212. A metadata link 214, such as a HTML link, may be displayed for each file displayed in display area 212. The metadata link permits a user to quickly access metadata associated with a particular file.

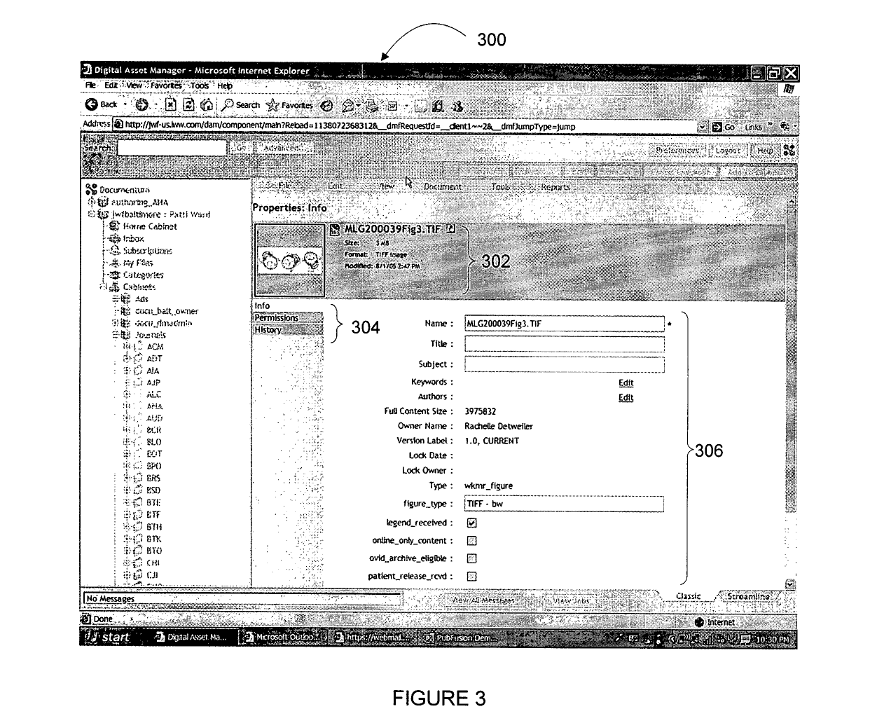

FIG. 3 is a diagram of a GUI 300 for an application running on processor 106 for managing metadata associated with content data. A user may access GUI 300 by selecting metadata link 214. Summary 302 may comprise information related to the associated content data, such as file name, file size, file format, and/or a modified and/or creation date. One or more categories 304 may identify different types of metadata. When a user selects a metadata category 304, metadata fields 306 may be displayed to the user. Some or all of the metadata fields 306 may be populated with metadata that was extracted by processor 106 when the associated content data was received at processor 106. Unpopulated metadata fields 306 may be completed by a user, and the associated data may be stored in storage device 108. When a user selects a different category 304, the displayed metadata fields 306 change to fields associated with the selected category.

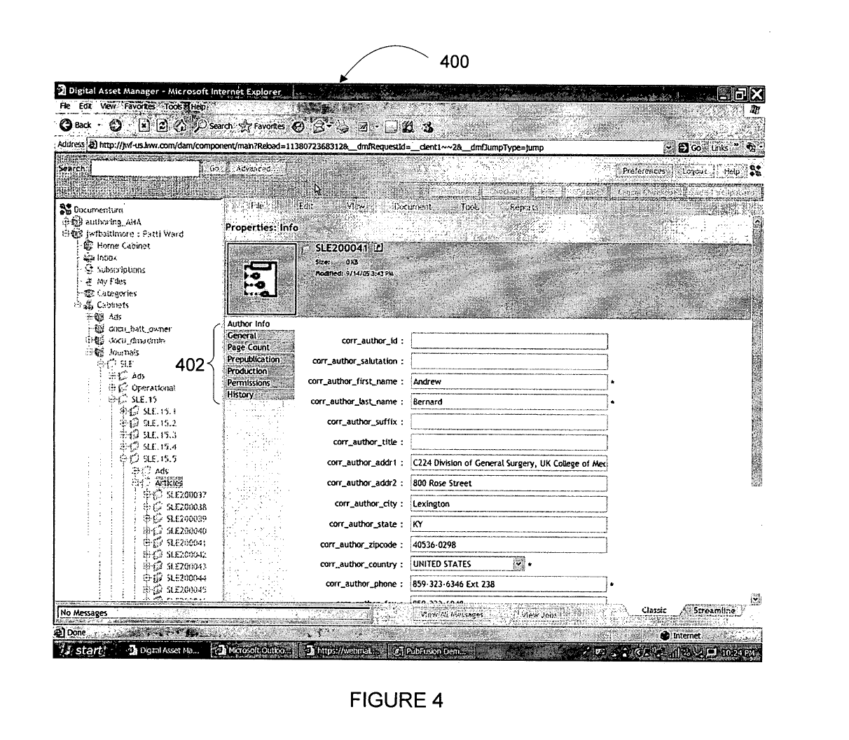

FIG. 4 is an alternate diagram of a GUI 400 for an application running on processor 106 for managing metadata associated with content data. A user may access GUI 400 by selecting metadata link 214. In FIG. 4, categories 402 indicate alternative metadata categories that may be populated by a user or from data extracted from contact data.

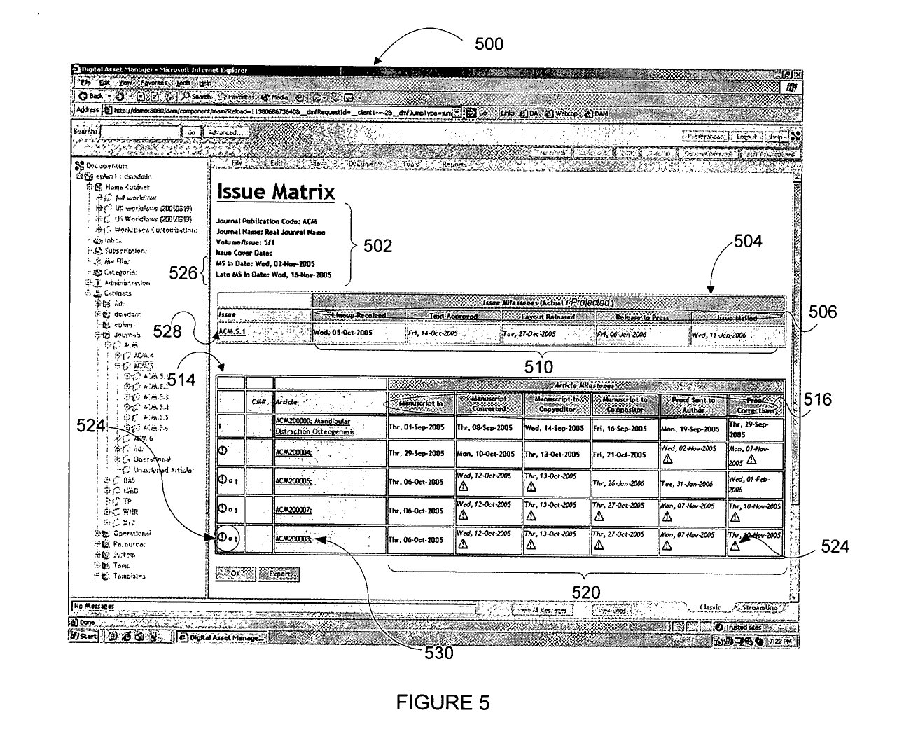

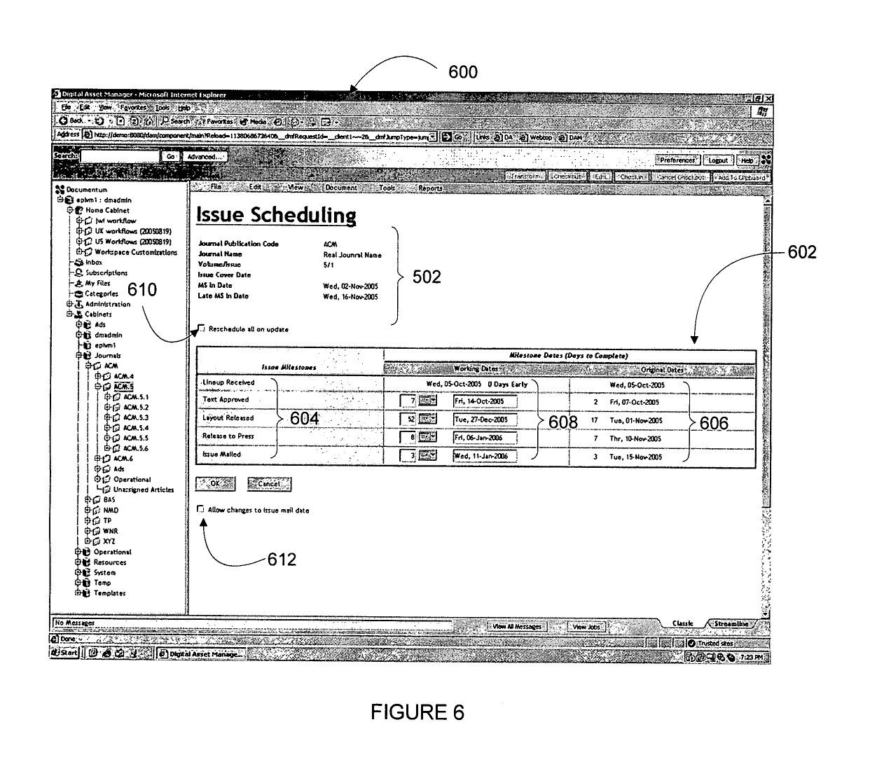

FIG. 5 is a diagram of a GUI 500 for an application running on processor 106 for managing publication level and/or content level milestones. A user may access GUI 500 through a “view” menu located along the top of the GUI. Summary 502 may comprise information related to a particular publication, such as a publication code name, a publication name, and/or publication issue data. Additionally, summary 502 may comprise data indicating external due dates 526. A publication matrix 504, such as an issue matrix may comprise a listing of user created issue milestones 506 and issue milestone deadlines 510. In FIG. 5, processor 106 used issue mail date as a publication scheduling control data to backwards generate data for the other identified issue milestone deadlines. An issue name 528 may be displayed as a hyperlink, and when selected by a user processor 106 may display an issue scheduling GUI (FIG. 6).

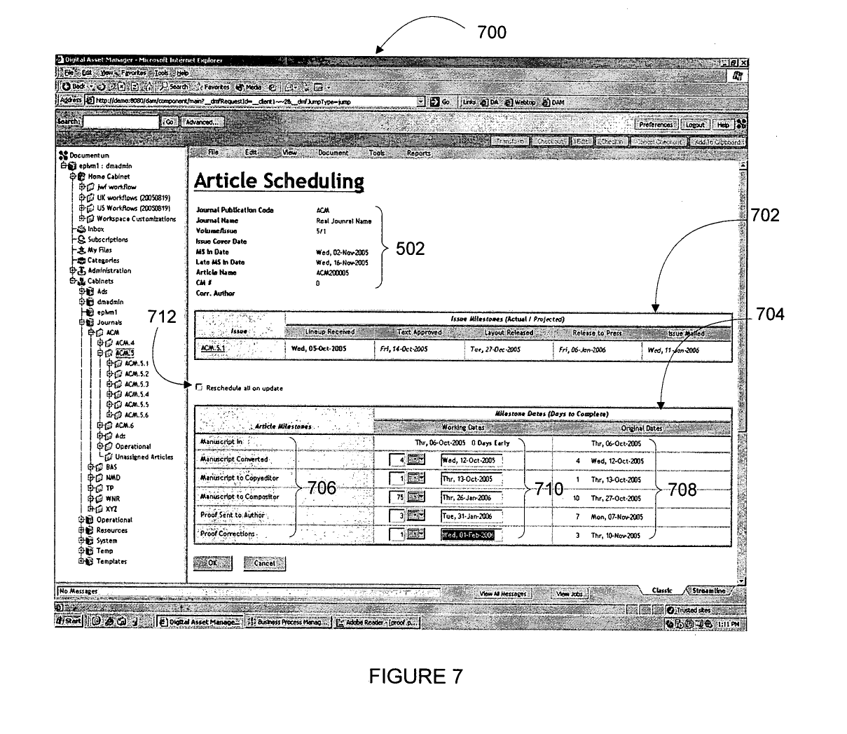

A content matrix 514, such as an article matrix may comprise a listing of user created article milestones 516 and article milestone deadlines 520. In FIG. 5, processor 106 forward generated article milestone deadlines from data indicating a manuscript in date. Article matrix 514 may additionally include graphics 524. Graphs may indicate article status information to a user, such as the date by which a milestone should be completed, if an article will delay an associated issue based on the current schedule, whether a portion of the article data is missing, if a portion of the article includes color, and/or whether all of the milestones for an article have been completed. An article name 530 may be displayed as a hyperlink, and when selected by a user processor 106 may display an article scheduling GUI (FIG. 7).

FIG. 6 is a diagram of a GUI 600 for an application running on processor 106 for customizing an issue schedule. A user may access GUI 600 by selecting a particular issue hyperlink, such as hyperlink 528. GUI 600 may comprise summary 502; publication matrix 602, such as issue scheduling matrix; and one or more select boxes. Issue scheduling matrix 602 may display issue milestones 604, original issue milestone deadlines 606, and customizable issue milestone deadlines and/or durations 608. When issue scheduling GUI 600 is initially displayed customizable issue milestone deadlines and/or durations 608 may be identical to original issue milestone deadlines 606. A user may modify one or more issue milestone deadlines and/or durations by selecting the appropriate field. A set of rules may be programmed in processor 106 to prevent a user from assigning specific data for a milestone deadline and/or duration. These rules may be programmed based on the use of a particular calendar and/or to prevent a user from selecting a previously passed date. Customizable milestone dates and durations may be linked to one another such that changing one field will cause processor 106 to change the other field. When modifying the issue scheduling matrix, a user may select box 610 to cause processor 106 to retain the previously defined milestone durations. (e.g., a change to any milestone date will cause processor 106 to automatically change all other milestone dates in accordance with the previously established milestone durations). Additionally, a user may select or unselect box 612 depending on whether the user wants the issue mail milestone deadline to change in response to a modification to another milestone deadline and/or duration.

FIG. 7 is a diagram of a GUI 700 for an application running on processor 106 for customizing an article schedule. A user may access GUI 700 through a “view” menu located along the top of the GUI or alternatively by selecting an article hyperlink, such as hyperlink 530. GUI 700 may comprise summary 502; publication matrix, such as issue matrix 702; content scheduling matrix 704, such as article scheduling matrix; and one or more select boxes 712. Issue matrix 702 may display issue milestones and corresponding deadlines. Article scheduling matrix 704 may display article milestones 706, original article milestone deadlines 708, and customizable article milestone deadlines and/or durations 710. When article scheduling GUI 700 is initially displayed customizable article milestone deadlines and/or durations 710 may be identical to original article milestone deadlines 708. A user may modify one or more article milestone deadlines and/or durations by selecting the appropriate field. A set of rules may be programmed in processor 106 to prevent a user from assigning specific data for a milestone deadline and/or duration. These rules may be programmed based on the use of a particular calendar and/or to prevent a user from selecting a previously passed date. Customizable milestone dates and durations may be linked to one another such that changing one field will cause processor 106 to change the other field. When modifying the article scheduling matrix, a user may select box 712 to cause processor 106 to retain the previously defined milestone durations. (e.g., a change to any milestone date will cause processor 106 to automatically change all other milestone dates in accordance with the previously established milestone durations). Any changes to article milestone deadlines and/or durations may be stored in storage device 108 in real-time or in delayed time.

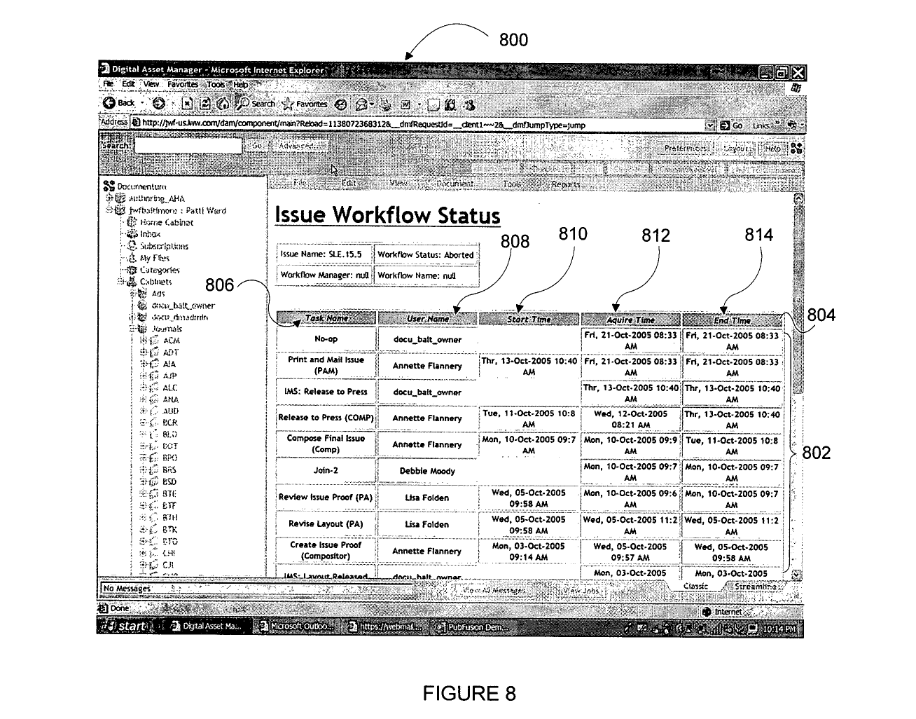

FIG. 8 is a diagram of a GUI 800 for an application running on processor 106 that monitors the status of an issue workflow. A user may access GUI 800 through a “view” menu located along the top of the GUI. GUI 800 may comprise an issue workflow status matrix 802. Issue workflow status matrix 802 may comprise a header 804 describing the type of data included within matrix 802. Header 804 may include descriptions such as task name 806, user name 808, start time 810, acquire time 812, and/or end time 814. Data associated with task name 806 indicates the individual process and/or steps that comprise issue workflow. Data associated with user name 808 indicates a user and/or group responsible for performing the associated task. Data associated with start time 810 indicates a date and/or time that a user began performing the associated task. Data associated with acquire time 812 indicates a date and/or time that content data was available for a user to being performing the associated task. A comparison of the acquired data to the start data reflects a user's delay in beginning work on the associated task. Data associated with end time 814 indicates a date and/or time the associated task was completed. End time data 814 may be used by the system to track the completion of issue milestone deadlines. The data displayed within issue workflow status matrix 802 may be compiled from raw data stored in storage device 108 and/or by processor 106 performing arithmetic and/or logic operations on raw or other processed data stored in storage device 108.

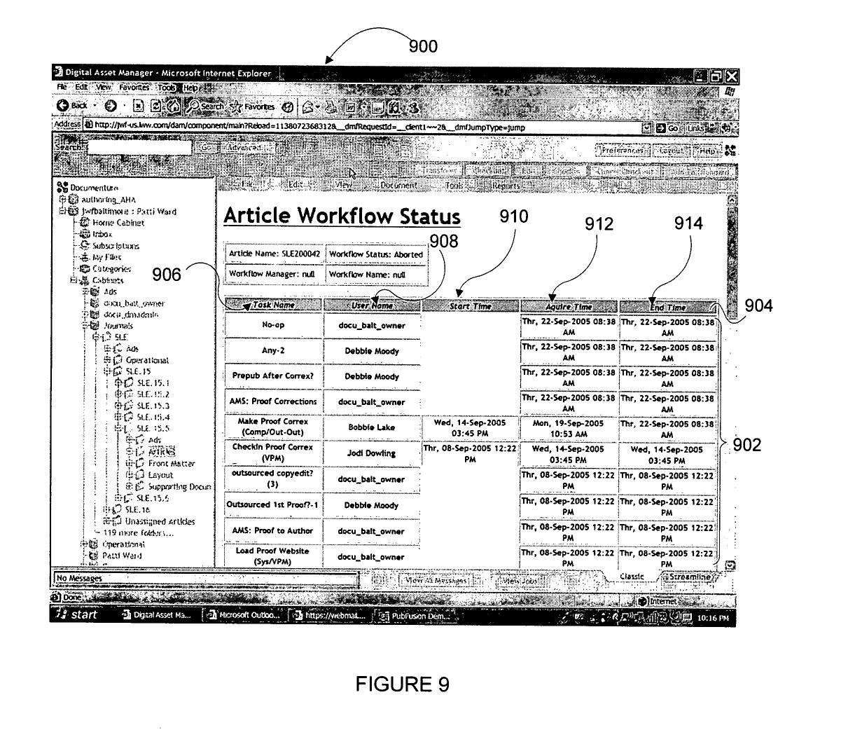

FIG. 9 is a diagram of a GUI 900 for an application running on processor 106 that monitors the status of an article workflow. A user may access GUI 900 through a “view” menu located along the top of the GUI. GUI 900 may comprise an article workflow status matrix 902. Article workflow status matrix 902 may comprise a header 904 describing the type of data included within matrix 902. Header 904 may include descriptions such as task name 906, user name 908, start time 910, acquire time 912, and/or end time 914. Data associated with task name 906 indicates the individual processor and/or steps that make up the issue workflow. Data associated with user name 908 indicates a user or group responsible for performing the associated task. Data associated with start time 910 indicates a date and/or time that a user began performing the associated task. Data associated with acquire time 912 indicates a date and/or time that content data was available for a user to being performing the associated task. A comparison of the acquired data to the start data reflects a user's delay in beginning work on the associated task. Data associated with end time 914 indicates a date and/or time the associated task was completed. End time data 914 may be used by system to track the completion of article milestone deadlines. The data represented within article workflow status matrix 902 may be compiled from raw data stored in storage device 108 and/or by processor 106 performing arithmetic and/or logic operations on raw or other processed data stored in storage device 108.

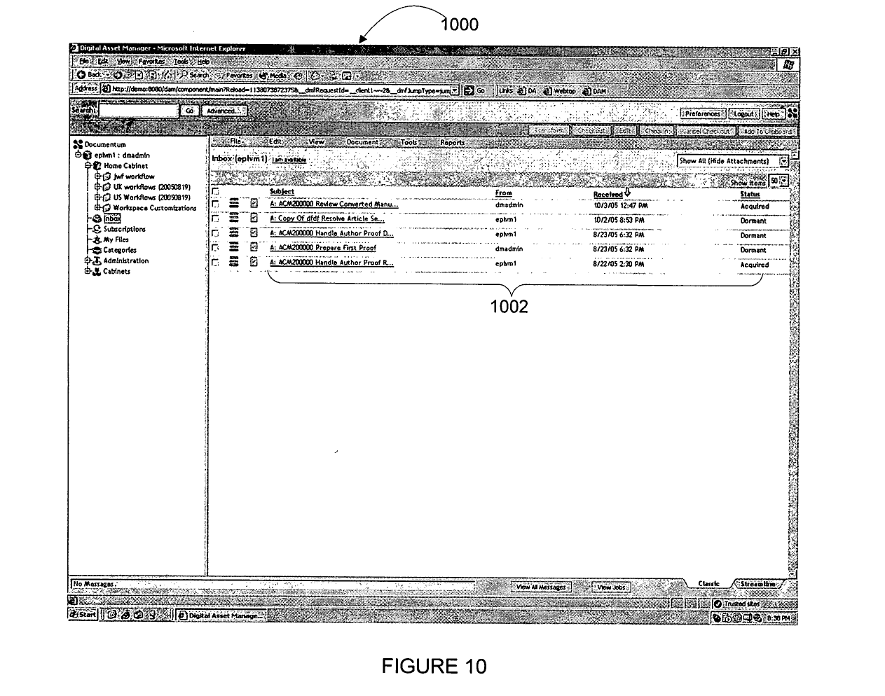

FIG. 10 is a diagram of a GUI 1000 for an application running on processor 106 for providing information to a user of publication monitoring system. In FIG. 10, notifications may be displayed in a user's Inbox 1002. In FIG. 10, Inbox 1002 may display information relating to a notification, such as subject, transmitting party, date received, and/or a status indication.

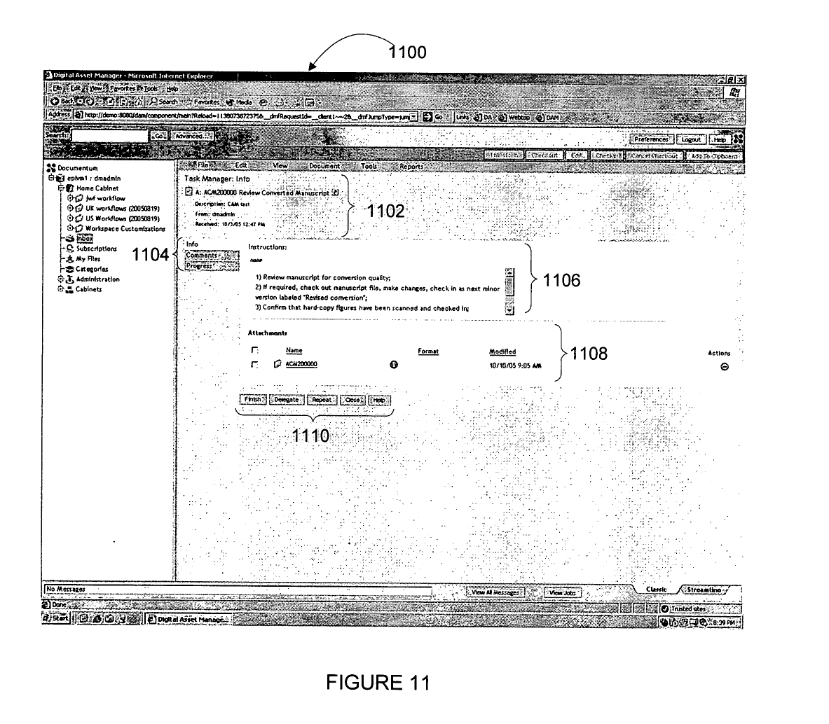

FIG. 11 is a diagram of a GUI 1100 for an application running on processor 106 for conveying task information to a user. GUI 1100 may be accessed when a user selects a notification from GUI 1000. GUI 1100 may comprise notification information. In FIG. 11, summary 1102 displays data relating to the notification. In FIG. 11, this data includes the subject of the notification message, a description, the transmitting party, and the date received. Categories 1104 may provide different information relating to the notification message. A notification message 1106 provides a user with specific notification information. Additionally, attachment information 1108 may be provided to the user. Attachment information may include report data and/or content data which a user may perform a publication level and/or content level task on. One or more action buttons 1110 may be included which may provide data back to processor 106 when executed.

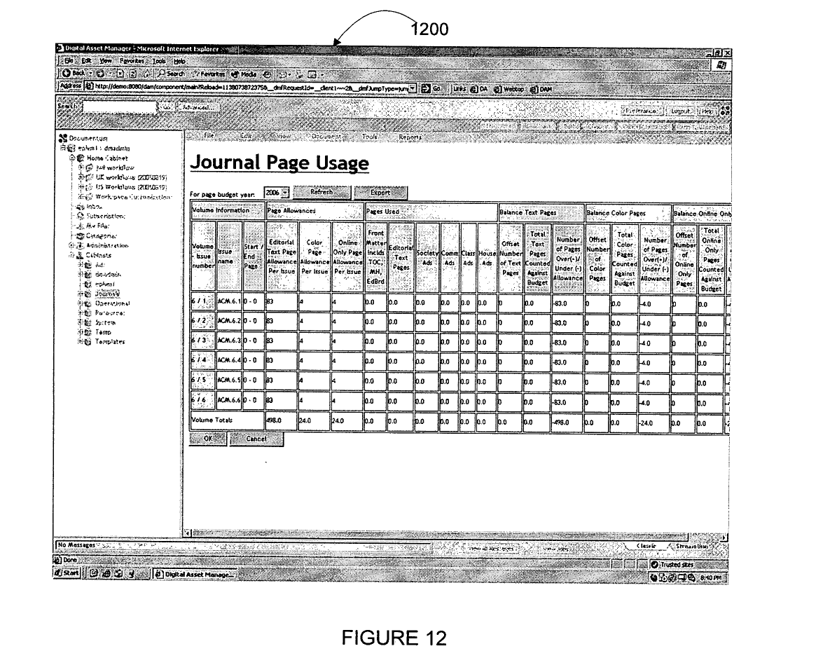

FIG. 12 is a diagram of a GUI 1200 for an application running on processor 106 for a usage report. In FIG. 12, an exemplary journal page usage report is shown. GUI 1200 may be generated by processor 106 based on data stored in storage device 108. Processor 106 may perform statistical analyses on data stored in storage device 108 to generate GUI 1200. A user viewing GUI 1200 can review the types and amount of pages configured for use in a particular publication. Additionally, a user can see how many of a particular type of page have been used and the remaining balance of pages available. This may assist a user in deciding what additional content should be added to the publication. Other types of report pages that may be generated by processor 106 based on data stored in storage device 108 may include an elapsed time report, an unassigned article report, a journal status report, an advertising report, or custom designed reports which may be based on stored metadata.

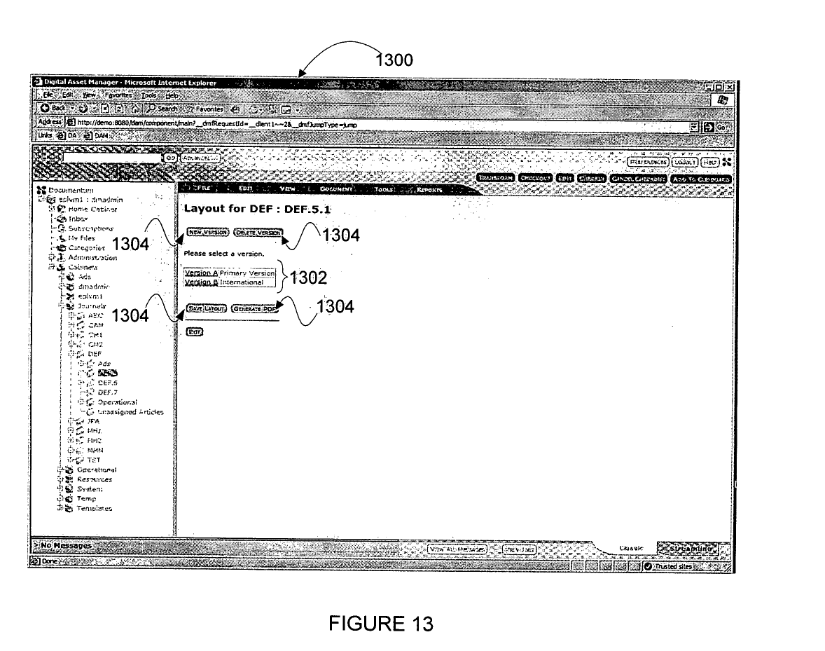

FIG. 13 is a diagram of a GUI 1300 for an application running on a processor 106 for selecting a version for a publication layout. In FIG. 13, a user may select a previously created layout version through a link 1302. Action buttons 1304 may be used to create a new layout version, delete a currently saved layout version, save a newly created layout versions, or generate an electronic version of a layout, such as a PDF file. The electronic version of a layout may be used to generate a printed version of the layout. Alternatively, the electronic version of the layout may be distributed to users of the system and/or publication subscribers through a computer-readable medium.

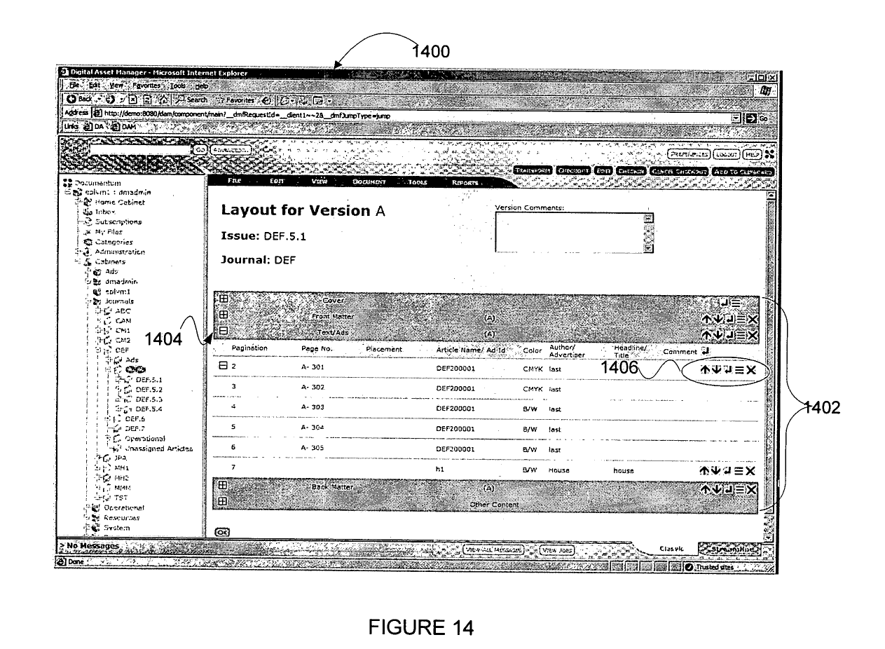

FIG. 14 is a diagram of a GUI 1400 for an application running on a processor 106 for managing the content included in a publication layout. GUI 1400 is an example of an interface that permits a user to assemble the content that is included in a publication. In FIG. 1400, expandable content fields 1402 designate the various portions of a publication, such as a cover, front matter, text/advertisements, and a back cover. As a user expands a content field 1402, additional information related to that field is presented to the user. Content field 1404 shows additional information related to text/advertisement information that is included within the selected publication. When a user adds an article to a publication layout, the system automatically determines the number of pages of the text/advertisement and separately lists each page under text/advertisement content field 1404. When a user adds an advertisement, no page number is assigned to the advertisement; however the system tracks the length of the advertisement within the pagination information. If a user decides to add a blank page, for example, between printed material pages, the system tracks the inclusion of this page and again accounts for it in the pagination of the publication layout. The listing of each individual page permits a user to verify the pagination to be used for the publication as well as customizing the layout. Customization may include, for example, specifying the color in which the content should be printed, which may be in color or in black and white. A user may use one of a number of action buttons 1406 to further customize the publication layout. Action buttons 1406 may include buttons which are designed to reorder the publication's page layout. Additionally, action buttons 1406 may permit a user to delete a page from the publication layout, or alternative insert a comment. Similar layout configurations may be performed on other portions of the publication, such as the cover, front matter, and/or back matter. Front matter may include information at or near the beginning of the journal, such as a table of contents, editorial boards, letters to the editor, erratum, and/or information for an author or subscriber. Back matter may include information at or near the end of the journal, such as filler advertisements, volume information, and/or editorial boards.

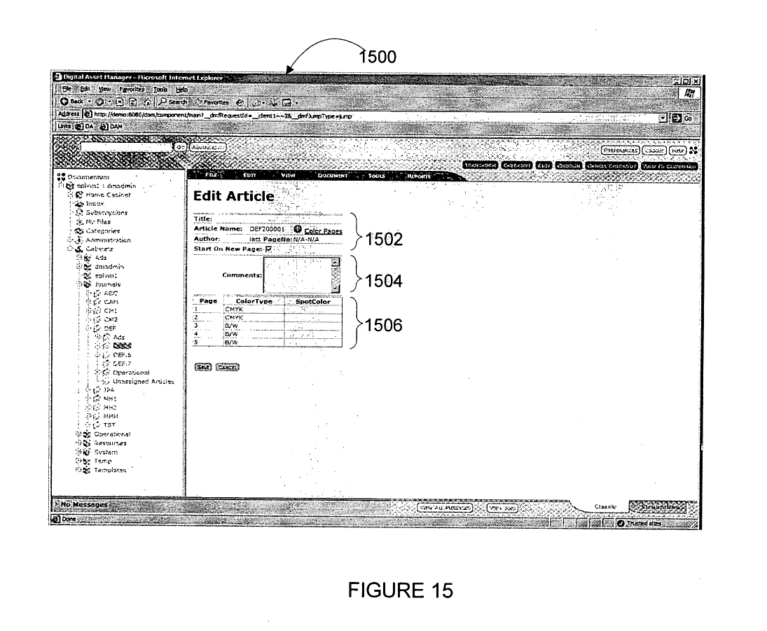

FIG. 15 is a diagram of a GUI 1500 for an application running on a processor 106 for configuring printed matter settings in a publication layout. Summary fields 1502 display information related to the selected print matter. This may include information related to an article to be included in a publication. Comment field 1504 permits a user to enter additional comments related to the selected printed matter. Configuration field 1506 permits a user to customize the appearance of the selected printed matter. Customization may include selecting the color sequence to be used for the selected printed matter. The color sequence may be assigned on a per page basis or globally for the selected printed matter.

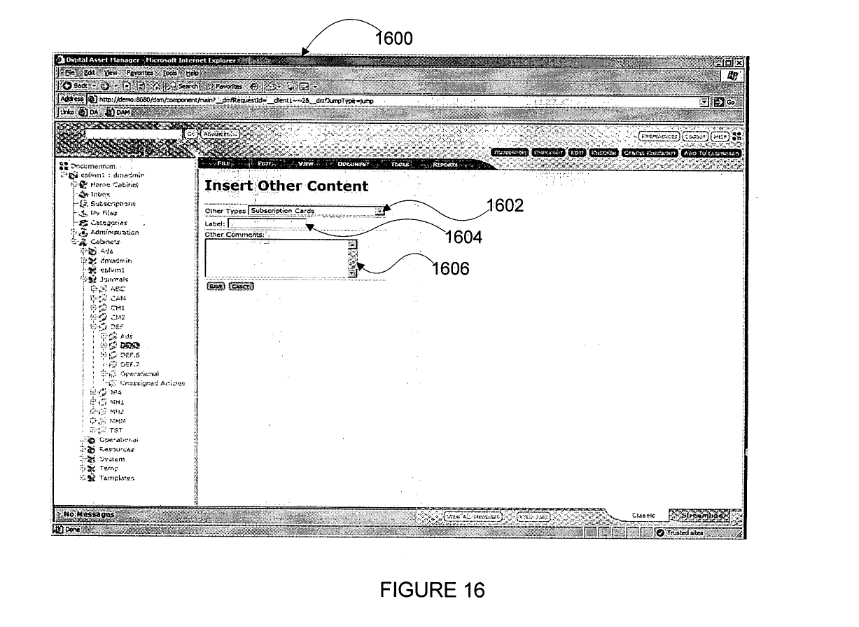

FIG. 16 is a diagram of a GUI 1600 for an application running on a processor 106 for inserting alternative data content. A user may use pull down menu 1602 to indicate the type of alternative data content being added. Alternative data content may include such items as subscription cards, market survey cards, journal reminders, and/or ancillary or supplementary content, such as promotional or informative compact discs. In label field 1604, a user may provide a description of the content type selected from pull down menu 1602. In comment field 1606, a user may provide additional comments regarding the alternative content data being added.

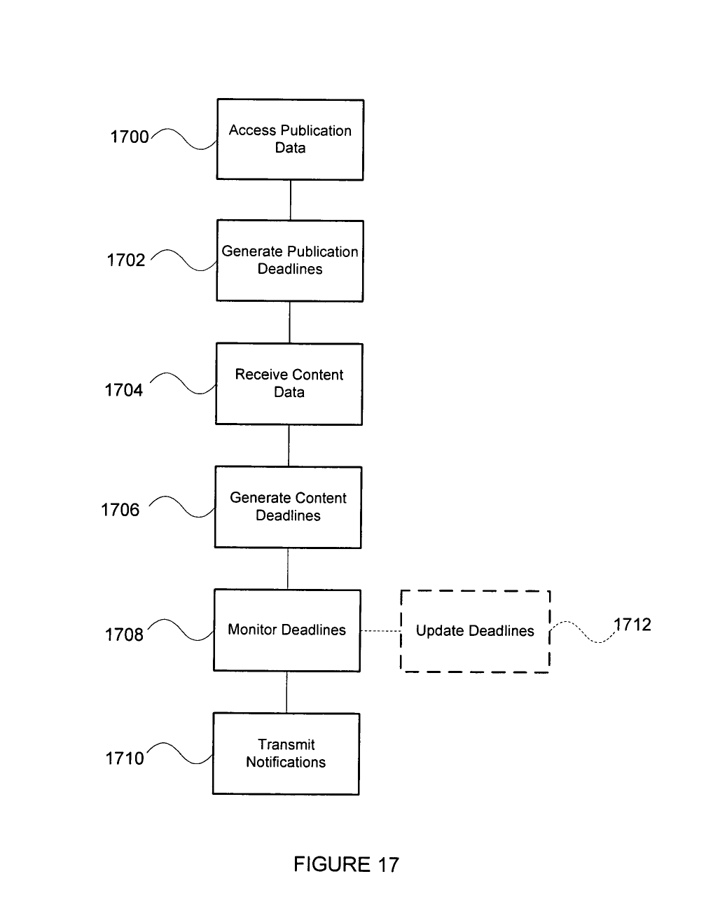

FIG. 17 is a partial flow diagram of a publication monitoring system. At act 1700 a processor accesses publication level data. At act 1702 a plurality of publication level milestone deadlines may be generated based on a publication parameter. The publication parameter may be a user defined parameter, such as a date by which a publication level milestone is to be completed. Publication monitoring system may use publication parameter as a starting point to generate other associated publication level milestone deadlines. Other publication level milestone deadlines may be forward or reverse generated depending upon how a user has configured the system.

At act 1704, the system may receive content data. Content data may be data that will be included in a publication, such as article text, an advertisement, graphics, charts, etc. When the system receives content data, portions of the data may be extracted as metadata. Content data as well as the metadata may be stored in a storage device. At act 1706 system may generate a plurality of content related milestone deadlines. Content related milestone deadlines may be generated in real-time when content data is received by the system. Alternatively, content related milestone deadlines may be generated in delayed time. Content milestone deadlines may be based on a user customizable parameter related to the content data, such as when the data was received by the system. Content milestone deadlines may be forward or reversed generated depending upon the system's configuration.

At act 1708 publication monitoring system may monitor milestone deadlines. Milestone deadlines may be monitored on a publication level and/or a content level. Monitoring of milestone deadlines may include detecting when the processes or steps comprising a milestone have been completed. The system may detect the completion of milestones by tracking tasks users perform on the associated content data. When a milestone has been completed, a notification to some or all of the users of the system may be transmitted at act 1710. Notification may keep decision makers informed of the publication and/or content data's progress through the system. Additionally, notification may inform persons responsible for performing a next task that content data is available and the task may be started.

Additionally, at act 1710, notifications may be transmitted by the system informing some or all of the users that a milestone has not been completed within its allotted time period. The system may determine that a milestone has not been completed where the duration in which to perform the milestone has expired prior to the assigned work being completed. This information may permit an authorized user to modify at least some of the remaining milestones.

At act 1712, a user may select to modify one or more publication level and/or content level deadlines. Some systems may be configured to initially apply deadlines that are shorter than a critical time limit. This may ensure that users have an allowable margin of freedom with which to reschedule milestone deadlines in order to still meet the critical time limit. Publication and/or content level deadlines may be modified based on a date or a milestone duration.

The method shown in FIG. 17, in addition to the other methods described above, may be encoded in a signal-bearing medium, a computer-readable medium such as a memory, programmed within a device such as one or more integrated circuits, or processed by a controller, a processor, or a computer. If the methods are performed by software, the software may reside in a memory resident to or interfaced to processor 106 or storage device 108, or any type of communication interface. The memory may include an ordered listing of executable instructions for implementing logical functions. A logical function may be implemented through digital circuitry, through source code, through analog circuitry, or through an analog source such as through an electrical, audio, or video signal stored or processed b logic. The software may be embodied in any computer-readable or signal bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal medium,” and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of machine-readable medium would include: an electrical connection (electronic) having one or more wires, a portable magnetic or optical disk, a volatile memory such as Random Access Memory “RAM” (electronic), a Read-Only Memory “ROM” (electronic), an Erasable Programmable Read-Only Memory (EPROM or Flash Memory) (electronic), or an optical fiber (optical). A machine-readable medium may also include a tangible medium upon which software is printed, as the software may be electronically stored as an image or in another format (e.g., through an optical scan), the compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A publication management system, comprising:
a processor configured to communicate with a network;
a storage device associated with the processor, the storage device containing publication process data related to a publication and content related data; and
the processor configured to reverse generate a plurality of publication deadlines from the publication process data and to forward generate a plurality of content deadlines from the content related data.

2. The system of claim 1, where the processor is configured to receive a user command associating the content related data with the publication when a last content deadline predates a first publication deadline.

3. The system of claim 2, where the publication process data comprises an issue mailing date.

4. The system of claim 3, where the content related data comprises a content data receive date.

5. The system of claim 4, where the processor detects a completion of one of the plurality of content deadlines through an event-driven process.

6. The system of claim 5, where the detection of the completion of one of the plurality of content deadlines occurs in real-time.

7. The system of claim 6, where the processor generates a notification to signify the completion of one of the plurality of content deadlines.

8. The system of claim 7, where the processor generates an alert if one of the plurality of content deadlines expires prior to completion.

9. The system of claim 1, where the processor is configured to receive a user command modifying at least one of the plurality of publication deadlines.

10. The system of claim 1, where the processor is configured to receive a user command modifying at least one of the plurality of content deadlines.

11. The system of claim 10, where the processor is configured to update all non-modified content deadlines in response to the modified content deadlines.

12. A method of monitoring a publication schedule, comprising:
storing publication related data;
accessing the publication related data;
reverse generating a plurality of publication deadlines from the publication related data;
receiving content data;
forward generating a plurality of content deadlines from the content data;
monitoring the plurality of content deadlines;
transmitting a notification related to the monitoring of the content deadlines.

13. The method of claim 12, where the act of monitoring the content deadlines is event-driven.

14. The method of claim 13, where the act of monitoring the content deadlines occurs in real-time.

15. The method of claim 14, further comprising transmitting a message to a user informing the user of a completion of at least one of the plurality of content deadlines.

16. The method of claim 15, further comprising generating an alert when at least one of the plurality of content deadlines expires prior to completion.

17. The method of claim 16, further comprising modifying at least one content deadline to permit content deadlines to be completed prior to a first publication deadline.

18. The method of claim 17, further comprising updating all non-modified content deadlines in response to the modified content deadlines.

19. The method of claim 16, further comprising modifying at least one publication deadline to permit content deadlines to be completed prior to a first publication deadline.

20. A computer readable storage medium containing a set of instructions for a process for executing the following steps:
storing publication related data;
storing content related data;
accessing the publication related data;
reverse generating a plurality of publication deadlines from the publication related data;
accessing the content related data;
forward generating a plurality of content deadlines from the content related data;
monitoring the content deadlines.
